(19) United States
(12) Patent Application Publication
(10) Pub. No.: US 2010/0238765 A1
(43) Pub. Date: Sep. 23, 2010

(54) RESERVOIR CHARACTERIZATION FROM MULTICOMPONENT MICROSEISMIC DATA

(76) Inventors: Vladimir GRECHKA, Missouri City, TX (US); Petr KOLINSKY, Borovany (CZ); Leo EISNER, Houston, TX (US); Peter M. DUNCAN, Houston, TX (US); Michael P. THORNTON, Houston, TX (US)

Correspondence Address: RICHARD A. FAGIN, P.O. BOX 1247, RICHMOND, TX, 77406-1247, US

(21) Appl. No.: 12/407,894

(22) Filed: Mar. 20, 2009

(51) Int. Cl. G01V 1/00

(52) U.S. Cl. 367/38

(57) ABSTRACT

A method for determining seismic anisotropy of subsurface rock formations includes measuring passive seismic signals at a plurality of locations above an area of the Earth's subsurface to be surveyed. The compressional- and shear-wave arrival times from at least one origin location of a seismic event occurring in the subsurface are determined from the measured seismic signals. The arrival times are inverted to obtain values of the seismic anisotropy parameters.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of imaging the Earth's subsurface using passive seismic detection techniques. More specifically, the invention relates to processing methods for passive seismic signals to improve the ability to detect subsurface seismic events from such signals and characterize reservoir.

2. Background Art

Passive seismic techniques are used to image and to characterize petrophysical properties of subsurface rock formations. Techniques known in the art for passive seismic data acquisition and processing are described, for example in U.S. Patent Application Publication No. 2008/0068928 filed by Duncan et al., the patent application for which is assigned to the assignee of the present invention.

One of the physical properties that is desired to be determined for characterization of subsurface rock formations is seismic anisotropy. Seismic anisotropy (i.e. dependence of the seismic velocities on direction of the propagation) is commonly observed both in large-scale studies (upper mantle, core-mantle boundary and inner core of the Earth) as well as in small-scale crustal imaging of seismic data used for mineral and petroleum exploration. In mineral and petroleum exploration, anisotropy is used for seismic reservoir imaging, obtaining rock type information, identification of fracture or stress orientations, monitoring of time-lapse changes in elastic properties, etc. Understanding the velocity anisotropy is important for precise and accurate location of induced microseismic events. However, inversion for seismic anisotropy remains difficult mainly due to a multiparameter nature of the problem and inability of conventional (controlled source) seismic reflection data to constrain the relevant parameters. Those issues are usually dealt with by making assumptions about the type of seismic anisotropy, and fitting acquired seismic data to the assumed model.

The foregoing difficulty in inversion for anisotropy can be alleviated if more measurements of seismic anisotropy are available. One such measurement of anisotropy is known as “shear-wave splitting”, which does not occur in isotropic media.

It is desirable therefore to have a method for measuring shear-wave splitting in addition to compressional-wave times with passive seismic measurement techniques that can be used in connection with petroleum and mineral exploration.

### SUMMARY OF THE INVENTION

A method for determining the effective seismic anisotropy of subsurface rock formations includes measuring passive seismic signals at a plurality of locations above an area of the Earth's subsurface to be surveyed. The compressional- and shear-wave arrival times of at least one seismic event occurring in the subsurface are determined from the measured seismic signals. The arrival times are inverted to estimate seismic anisotropy.

A method for monitoring a formation fracturing procedure according to another aspect of the invention includes recording seismic signals at selected positions near the Earth's surface proximate a wellbore during pumping of fracturing fluid into the wellbore. From the measured signals, shear wave arrival times and compressional wave arrival times are selected from at least one origin location of a seismic event occurring in the subsurface. The shear wave and compressional wave arrival times are inverted to obtain values of seismic anisotropy parameters. A position of a fluid front is determined from the inverted shear wave and compressional wave arrivals by determining a location of origin of at least one seismic event.

Other aspects and advantages of the invention will be apparent from the following description and the appended claims.

### BRIEF DESCRIPTION OF THE DRAWINGS

FIG. 1 shows an arrangement of seismic sensors used to measure seismic signals during an hydraulic fracturing operation.

FIG. 2 shows a particular example arrangement of seismic sensors used for passive seismic monitoring.

FIG. 3 shows an example procedure for characterization of rock properties from shear-wave splitting and compressional-wave arrival time measurements.

FIG. 4 shows arrival time of compressional, S1 and S2 waves with respect to offset for an example set of subsurface formations.

FIG. 5 shows a graph of two estimated anisotropy parameters for the example travel times of FIG. 4.

FIG. 6 shows a graph of two other estimated anisotropy parameters for the example travel times of FIG. 4.

### DETAILED DESCRIPTION

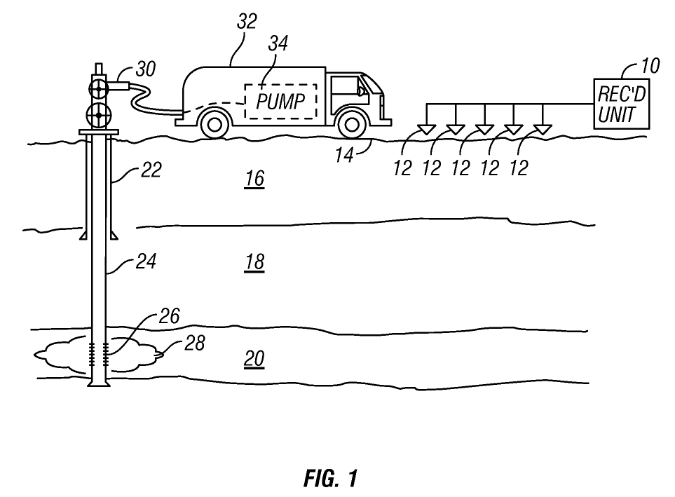

FIG. 1 shows seismic sensors as they would be used in one application of a method according to the invention. The example illustrated in FIG. 1 is associated with an application for passive seismic signal analysis known as “fracture monitoring.” It should be clearly understood that the application illustrated in FIG. 1 is only one possible application of a method according to the invention.

Each of a plurality of seismic sensors, shown generally at 12, is deployed at a selected position proximate the Earth's surface 14. In marine applications, the seismic sensors would typically be deployed on the water bottom in a device known as an “ocean bottom cable.” Additionally, the seismic sensors could be deployed in multiple shallow or deep boreholes in an arrangement known as a “buried array” The seismic sensors 12 in the present embodiment may be so called “three component” sensors. Three component sensors include three or more, typically mutually orthogonally oriented particle motion sensing elements. The sensing elements may be geophones, but may also be accelerometers or any other sensing device known in the art that is responsive to velocity, acceleration or motion of the particles of the Earth proximate the sensor. The seismic sensors 12 generate electrical or optical signals in response to the particle motion or acceleration along each of the three directionally sensitive components, and such signals are ultimately transmitted to a recording unit 10 for making a time-indexed recording of the signals from each sensor 12 for later interpretation by a method according to the invention.

In some examples, the seismic sensors 12 may be arranged in sub-groups having spacing therebetween less than about one-half the expected wavelength of seismic energy from the Earth's subsurface that is intended to be detected. Signals from all the sensors in one or more of the sub-groups may be added or summed to reduce the effects of noise in the detected signals. The adding or summing may be performed within the group itself, such as by connecting the sensors in electrical series, or may be performed, e.g., digitally in the recording unit 10.

A wellbore 22 is shown drilled through various subsurface rock formations 16, 18, through a hydrocarbon producing formation 20. A wellbore tubing 24 having perforations 26 formed therein corresponding to the depth of the hydrocarbon producing formation 20 is connected to a valve set known as a wellhead 30 disposed at the Earth's surface. The wellhead may be hydraulically connected to a pump 34 in a “fracture pumping unit 32.” The fracture-pumping unit 32 is used in the process of pumping a fluid, which in some instances includes selected size solid particles, collectively called “proppant”. Pumping such fluid, whether propped or otherwise, is known as hydraulic fracturing. The movement of the fluid is shown schematically at the fluid front 28 in FIG. 1. In hydraulic fracturing techniques known in the art, the fluid is pumped at a pressure which exceeds the fracture pressure of the particular producing formation 20, causing it to rupture, and form fissures therein. The fracture pressure is generally related to the pressure exerted by the weight of all the formations 16, 18 disposed above the hydrocarbon producing formation 20, and such pressure is generally referred to as the “overburden pressure.” In propped fracturing operations, the particles of the proppant move into such fissures and remain therein after the fluid pressure is reduced below the fracture pressure of the formation 20. The proppant, by appropriate selection of particle size distribution and shape, forms a high permeability channel in the formation 20 that may extend a great lateral distance away from the tubing 24, and such channel remains permeable after the fluid pressure is relieved. The effect of the proppant filled channel is to increase the effective radius of the wellbore 24 that is in hydraulic communication with the producing formation 20, thus substantially increasing productive capacity of the wellbore 24 to hydrocarbons.

The fracturing of the formation 20 by the fluid pressure creates seismic energy that is detectable by the seismic sensors 12. The time at which the seismic energy is detected by each of the sensors 12 with respect to the time-dependent position in the subsurface of the formation fracture created by the injected fluid is related to the acoustic velocity of each of the formations 16, 18, 20, and the position of each of the seismic sensors 12.

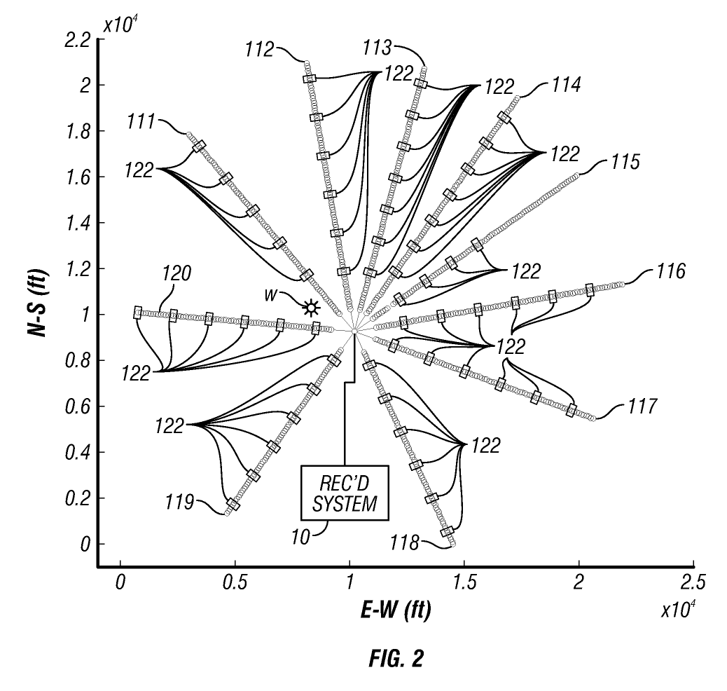

A particular arrangement of seismic sensors that may be used advantageously in some implementations is an array of seismic sensors such as shown in FIG. 2. The array shown in FIG. 2 generally includes radially extending lines 111 through 120 of spaced apart seismic sensors, individual examples of which are shown at 122, which can be three component geophones as explained above with reference to FIG. 1. The array shown in FIG. 1 can be configured and used, in some examples, as part of a fracture monitoring service sold under the trademark FRACSTAR, which is a registered trademark of Microseismic, Inc., Houston, Tex., one of the assignees of the present invention. In such monitoring service, seismic signals are detected while fluid is pumped into a subsurface formation from the surface through a wellbore W drilled through the subsurface formations. See, for example, U.S. Patent Application Publication No. 2008/0068928 filed by Duncan et al., and the patent application for which is assigned to Microseismic, Inc. for a description of fracture monitoring using passive seismic signals.

The arrangement of the seismic sensors shown in FIG. 2, however, is only one example of an arrangement of seismic sensors that may be used to acquire passive seismic signals according to the invention, and such arrangement should not be construed as a limit on the scope of the present invention. It is important, however that in the case of recording signals during fracture monitoring that the sensors are arranged in a plurality of azimuthal directions and at a plurality of distances (“offsets”) from the position of the wellbore. It should also be understood that in other implementations, passive seismic signals may be recorded for a selected period of time without pumping fluid into the subsurface formations. Accordingly, the arrangement shown in FIG. 2, and its use with fracture pumping, should not be construed as limitations on the scope of the present invention.

The recording system is disposed proximate the array and may include equipment (not shown separately) to be used to record the signals generated by the seismic sensors in each of the sensor lines 111-120. As explained above, the signals may be recorded individually for each sensor 122, or in some examples, selected numbers of adjacent seismic sensors in each line 111-120 may have their signals combined or summed by electrical series connection or other electrical configuration, or the signals may be equivalently summed in the recording system 10. The recording system 10 may include a general purpose, programmable computer (not shown separately) for processing the recorded signals, and storing or displaying the signals on, for example, a computer display according to the invention. Processing signal recordings according to the invention may be also performed at any other location.

Recording seismic signals generated by the sensors 122 in the array may be performed continuously over a selected period of time, for example from several minutes to several weeks in duration. In other examples, signal recording may take place over a time period extending as long as several years in duration. Thus, for each sensor (or selected groups of sensors) a signal recording will include signal amplitude with respect to time for the entire selected recording time interval, for each of the three components of motion detected by each seismic sensor.

The recorded seismic signals can be scanned to determine the presence of one or more events that may be reasonably inferred to be of seismic origin. Such scanning may include, for example, identifying signal amplitudes in the recorded signals that exceed a selected threshold (amplitude peaks). When one or more of such events are detected in a plurality of the recorded signals, the time of arrival of each such event in each recorded signal is determined in order to establish that the events are possibly of seismic origin or by other detection criteria such as those discussed in Duncan et al. patent application publication referred to above. In the present invention, it is believed possible to determine seismic anisotropy only by measuring times of arrival of mutually perpendicular quasi S-waves (S1 and S2), or in other words, to measure the spatial distribution of shear-wave splitting, if in addition compressional-wave arrival times are known the full type and strength of anisotropy can be inverted.

Shear-wave splitting is the difference between the arrival times of S1 and S2 waves. In the present example, it can be obtained by rotating a portion of three-component trace containing both S1- and S2-waves in such a way to place them on different components. Then, the shear-wave splitting is found from the location of maximum of the cross-correlation of the rotated traces. Another possible technique might be to pick the time of the first maximum or minimum (amplitude peaks) in the recorded seismic signals. To pick the amplitudes automatically, a two-step procedure may be used. First, all peak amplitudes within a predetermined time interval (the interval being predetermined from the identified seismic event, using, e.g., signal to noise ratio detection) on each signal recording (“trace”) along each receiver line are identified. Next, is to manually (e.g., visually) select a particular event arrival, typically a trace where the event arrival has the apparent best signal-to-noise ratio, and then determine arrival times for each sensor in the sensor array from each of the corresponding amplitude peaks.

A similar arrival time selection procedure may also be applied to determine compressional (P) wave arrivals in the recorded signals. Typically, the sensor signal components in the vertical plane are used to determine P wave arrivals. One technique for determining anisotropy parameters from the detected arrivals is to perform inversion with respect to the arrival times of all three detected arrival times of compressional-, S1- and S2-waves. Such an inversion is nonlinear and consists of searching (e.g., grid search, gradient, etc.) of an optimal model, source location, and origin times. This sort of inversion generally cannot be applied to conventional active-source reflection seismic data because S-waves are typically either not excited or are not recorded at sufficiently large distances from the seismic energy sources to be able to estimate anisotropy in a unique fashion. In passive seismic data, however, shear-waves are excited naturally and the acquisition geometry such as shown in FIG. 2 is normally designed to have the required distances from the event hypocenters to reasonably constrain the inversion.

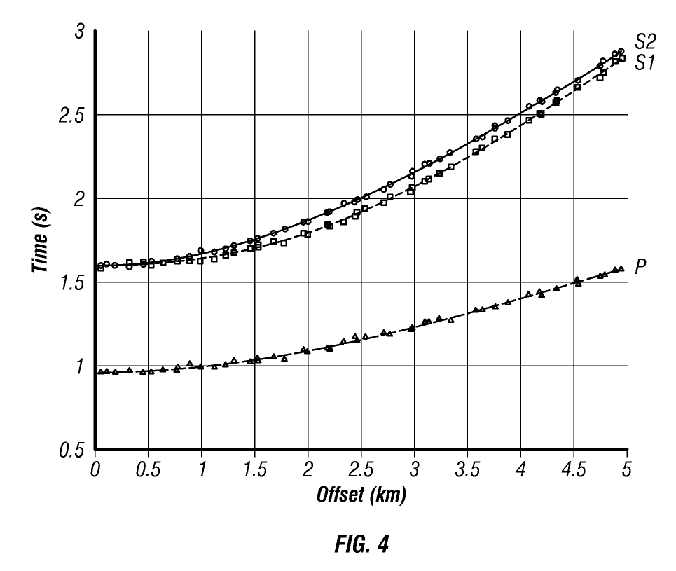

To illustrate that the foregoing inversion is feasible, a model was constructed of a vertically transversely isotropic (VTI) subsurface, and 200 microseismic events were simulated within the modeled formations. The arrival times from each event to a plurality of receivers located at the Earth's surface were calculated. The calculated travel times were then contaminated with random noise that has a standard deviation of 10 milliseconds. The noisy times were then used as an input for the inversion. The inversion searches for the unknown event origin time, event location, and the effective VTI parameters. The VTI parameters include the vertical compressional- and S-wave velocities and Thomsen coefficients ε, δ, and γ (see, e.g., U.S. Pat. No. 4,888,743 issued to Thomsen). FIG. 4 displays the times of compressional-, S1-, and S2-waves (black, blue, and red circles, respectively) for a particular event as functions of the offset from the estimated event hypocenter. The predicted compressional-, S1-, and S2-wave times are shown in FIG. 4 with black, blue, and red lines, respectively.

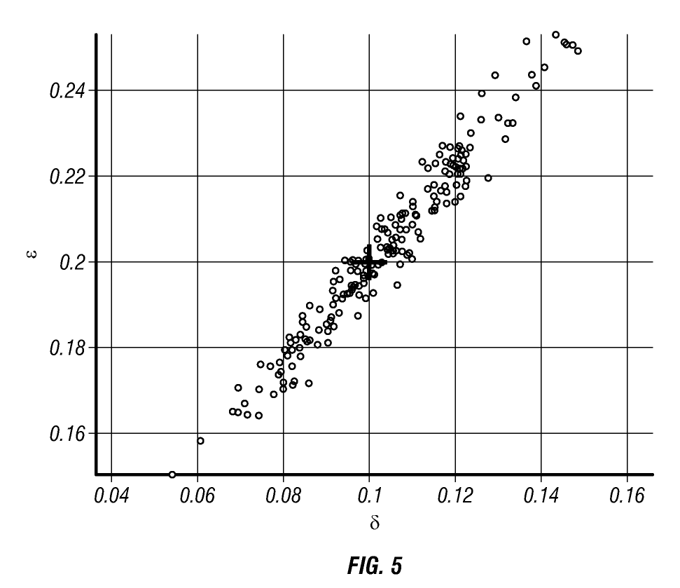

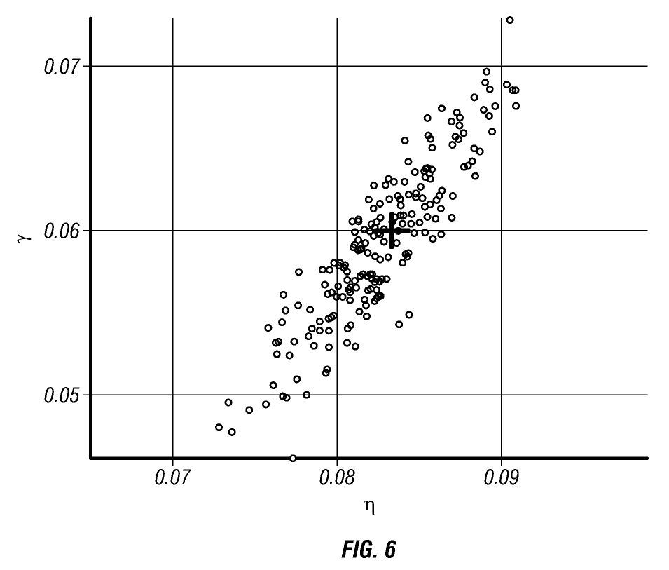

The anisotropic coefficients ε and δ estimated for each of 200 events are presented in FIG. 5 with gray circles. The cross in the center of FIG. 5 indicates the correct values of the foregoing two parameters. The spread of the estimates is due to noise in the data. Likewise, the estimated (circles) and exact (cross) Thomsen γ and the anellipticity coefficient η conventionally defined as η=(ε−δ)/(1+2δ) are displayed in FIG. 6.

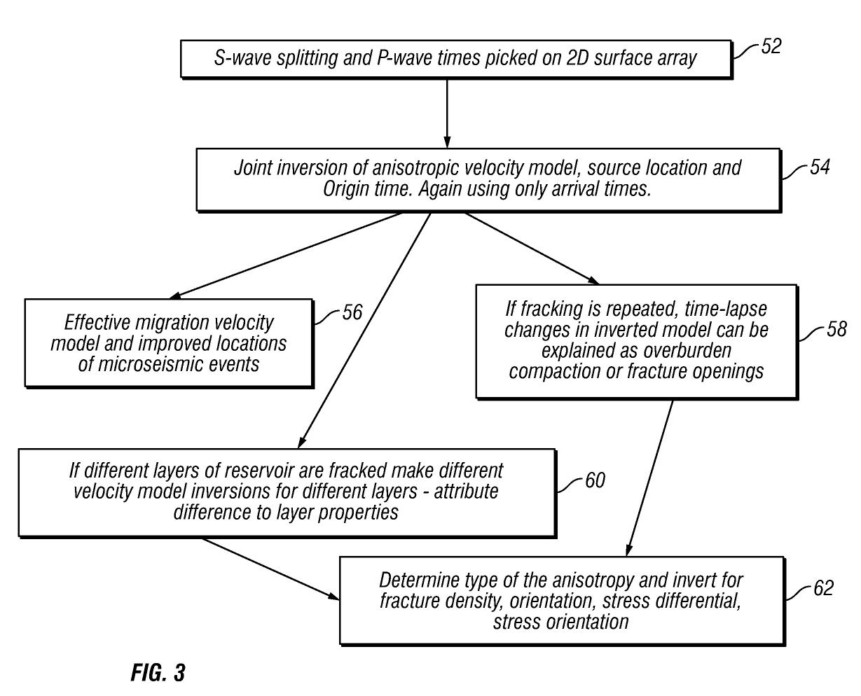

An example procedure using compressional-wave and shear-wave splitting times determined as explained above will be explained with reference to FIG. 3. At 52, the compressional-wave and shear-wave splitting times are determined for one or more seismic events, as explained above. Those times may be used, at 54, as input to an inversion procedure to determine the effective anisotropy parameters. Such parameters may be the effective anelliptic parameters (see, e.g., U.S. Pat. No. 6,985,405 issued to Ren et al.) or may be the Thomsen anisotropy parameters (see, e.g., U.S. Pat. No. 4,888,743 issued to Thomsen), as explained above. At 56, the effective seismic migration velocities may be determined.

At 58, if the passive detecting of seismic energy is performed as explained with reference to FIG. 1, for example, in the case in which fracture pumping takes place, the process above for determining anisotropy parameters may be repeated at selected times as the fracture induced by the fluid pumping propagate within a particular subsurface rock formation. If the anisotropy parameters are determined to change with respect to time and movement of the fracture front, such changes may be in part the result of compaction of the formations overlying the fractured formation (overburden compaction), or the result of opening of new and/or extended fractures in the rock formations.

At 60, if during fracture pumping (FIG. 1) operations more than one subsurface rock formation is subject to induced fracturing, the process explained above may be repeated for each suck rock formation. Changes that may be observed in the anisotropy parameters may be inferred as resulting from the different fracture properties of each such formation subject to fracturing.

At 62, for each case in which repeated determination of anisotropy parameters is performed, e.g., for fracture front monitoring as shown at 58 or for multiple formations being fractured, at 60, an inversion procedure may be performed in which the results are the density of the fractures, the orientation of the fractures, or the maximum and minimum horizontal stresses in the formation and the orientations thereof.

Methods according to the invention may provide for better determination of formation seismic anisotropy and better characterization of subsurface rock formations than methods known in the art prior to the present invention. The invention provides an inversion for effective anisotropy using only seismic event arrival times from passive seismic data, and does not require the use of polarization as is required with techniques known in the art. The invention provides inversion of general anisotropy as a result of using a dense array of sensors having multiple offsets and multiple azimuths. Previous inversion techniques used with active source seismic acquisition have relatively limited offsets or apertures and as a result therefore have to make assumptions about the type of anisotropy in order to achieve acceptable inversion results.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for determining effective seismic anisotropy of subsurface rock formations, comprising:
measuring passive seismic signals at a plurality of locations above an area of the Earth's subsurface to be surveyed;
selecting, from the measured signals, shear wave arrival times and compressional wave arrival times from at least one origin location of a seismic event occurring in the subsurface;
inverting the shear wave and compressional wave arrival times to obtain values of seismic anisotropy parameters; and
at least one of storing and displaying the anisotropy parameters.

2. The method of claim 1 further comprising determining a location of origin of at least one seismic event from the arrival times.

3. The method of claim 1 further comprising repeating the measuring passive seismic signals, selecting arrival times, inverting the arrival times, and storing or displaying anisotropy parameters at at least one later time.

4. The method of claim 1 further comprising inverting the compressional and shear arrival times for the anisotropy and using the anisotropy parameters to determine seismic migration velocities.

5. The method of claim 1 further comprising using the anisotropy parameters to determine at least one of density of fractures in subsurface formations, orientation of fractures in the subsurface formations, maximum and minimum horizontal stresses in the subsurface formations and orientations thereof.

6. A method for monitoring a formation fracturing procedure, comprising:
recording seismic signals at selected positions near the Earth's surface proximate a wellbore during pumping of fracturing fluid into the wellbore;
selecting, from the measured signals, shear wave arrival times and compressional wave arrival times from at least one origin location of a seismic event occurring in the subsurface;
inverting the shear wave and compressional wave arrival times to obtain values of seismic anisotropy parameters; and
determining a position of a fluid front from the inverted shear wave and compressional wave arrivals by determining a location of origin of at least one seismic event.

7. The method of claim 6 further comprising repeating the inverting the shear wave and compressional wave arrival times and determining a position of a fluid front at at least one later time.

8. The method of claim 7 further comprising determining at least one of density of fractures in subsurface formations, orientation of fractures in the subsurface formations, maximum and minimum horizontal stresses in the subsurface formations and orientations thereof from the repeated inverting shear wave and compressional wave arrival times and determining the fluid front location.
